(19) United States
(12) Patent Application Publication
(10) Pub. No.: US 2002/0071973 A1
(43) Pub. Date: Jun. 13, 2002

(54) Method for operating a HTM fuel cell and a HTM fuel cell battery

(76) Inventors: Armin Datz, Poxdorf (DE); Ulrich Gebhardt, Langensendelbach (DE); Manfred Waidhas, Nurnberg (DE)

Correspondence Address: LERNER AND GREENBERG, P.A., Post Office Box 2480, Hollywood, FL, 33022-2480, US

(21) Appl. No.: 09/968,298

(22) Filed: Oct. 1, 2001

Related U.S. Application Data
(63) Continuation of application No. PCT/DE00/00680, filed on Mar. 3, 2000.

(30) Foreign Application Priority Data
Mar. 29, 1999 (DE) 199 14 252.1

(51) Int. Cl. H01M 8/04; H01M 8/08

(52) U.S. Cl. 429/13; 429/24; 429/46

(57) ABSTRACT

A method for operating an HTM fuel cell and to a fuel cell battery. An electrolyte of the fuel cell contains phosphoric acid, a normal freezing point of which is 42° C. The freezing point is reduced by adding at least water as an additive to such an extent that the start/stop operation of the fuel cell, as is required, for example, in mobile fuel cell applications, can be achieved.

### CROSS REFERENCE TO RELATED APPLICATION

This application is a continuation of copending International Application No. PCT/DE00/00680, filed Mar. 3, 2000, which designated the United States.

### BACKGROUND OF THE INVENTION

1. Field of the Invention

The invention relates to a method for operating a high-temperature membrane (HTM) fuel cell and a fuel cell battery. The fuel cell has an electrolyte containing phosphoric acid to which water is added to reduce the freezing point of the phosphoric acid.

The polymer electrolyte membrane fuel cell, which as its electrolyte has a base polymer to which [—SO₃H]-groups are attached, is known. In this case, the electrolytic conduction takes place via hydrated protons. The membrane accordingly needs liquid water, i.e. water that under standard pressure requires operating temperatures of below 100° C., in order to ensure proton conductivity. This results in the problem that the process gases flowing in at temperatures of above approximately 65° C. have to be humidified.

A starting point for eliminating the restriction on the operating temperature is that of using a different membrane (which may also be an ion exchange membrane) and/or a matrix with free and/or physically bonded and/or chemically bonded phosphoric acid as the electrolyte for a fuel cell instead of the membrane that contains [—SO₃H]-groups. The fuel cell is known as a high-temperature membrane fuel cell (HTM fuel cell).

However, when producing a membrane fuel cell with free phosphoric acid, a freezing problem arises at temperatures below 50° C., i.e. when starting up the fuel cell installation, since phosphoric acid crystallizes at temperatures below 42° C. While in the liquid state the resistance of the phosphoric acid electrolyte is sufficiently low to allow autothermal heating of the cell. When crystalline phosphoric acid is present in the electrolyte, the resistance rises to such an extent that the battery does not start without further measures. This causes a problem in particular when the fuel cell is run in start/stop mode, i.e. for example in mobile applications.

The documented prior art has disclosed fuel cells that contain phosphoric acid as the electrolyte. These fuel cells, which are known as phosphoric acid fuel cells (PAFCs) have a solid-state matrix, in which phosphoric acid is stored, these fuel cells being operated at relatively high temperatures. Since it is known that phosphoric acid crystallizes at temperatures below 40° C., additives are added in order to reduce the melting point. Specifically, salts or acids for reducing the melting point are described in U.S. Pat. No. 5,219,675. Particularly in U.S. Pat. No. 5,302,471, the water vapor which forms when operating at high temperatures condenses as water during cooling and is taken up by the individual electrode units containing phosphoric acid, so that the melting point is reduced, and is then evaporated out of these units again when the fuel cells are operating. Finally, Japanese Patent Application JP 11-154529 A, which is not a prior art publication, specifically discloses a PEM fuel cell configuration in which water vapor is fed in via the upstream reformer.

### SUMMARY OF THE INVENTION

It is accordingly an object of the invention to provide a method for operating a HTM fuel cell and a HTM fuel cell battery that overcomes the above-mentioned disadvantages of the prior art methods of this general type, which method allows autothermal heating of the fuel cell at temperatures of below 40° C.

With the foregoing and other objects in view there is provided, in accordance with the invention, a method for operating a high-temperature membrane (HTM) fuel cell having an electrolyte containing phosphoric acid. During a cooling down of the HTM fuel cell from a working temperature, water is metered water to the phosphoric acid and/or generated in the HTM fuel cell to be added to the phosphoric acid in an amount of from 30 to 60% by weight, with a result that a freezing point of the phosphoric acid is reduced to a desired level.

In the method according to the invention for operating a high-temperature membrane (HTM) fuel cell, at least one additive, which has the effect of reducing a freezing point of phosphoric acid in the electrolyte, is added to the phosphoric acid contained in the electrolyte. For this purpose, the electrolyte of the HTM fuel cells containing the phosphoric acid, has at least one additive selectively added to the phosphoric acid.

In an associated HTM fuel cell battery, which contains a stack with at least one fuel cell unit, the fuel cell unit contains phosphoric acid in the electrolyte in which the freezing point of which has been reduced.

In accordance with an added mode of the invention, there is the step of selecting the amount of the water to be in a range from 40 to 57% by weight of the phosphoric acid. Alternatively, one can select the amount of the water such that the freezing point of the phosphoric acid is reduced by at least 40° C.

In an additional mode of the invention, there are the steps of using hydrogen as a fuel gas and air as an oxidizing agent in the HTM fuel cell, and metering the air to the hydrogen at an anode and the hydrogen is metered to oxygen at a cathode, in an amount which is such that the amount of the water generated reduces the freezing point of the phosphoric acid by at least 40° C.

In accordance with another mode of the invention, there is the step of monitoring an electrical resistance of the HTM fuel cell for controlling the metering of the water and the generation of the water.

In accordance with a further mode of the invention, there is the step of using the HTM fuel cell in a HTM fuel cell battery.

With the foregoing and other objects in view there is provided, in accordance with the invention, a method for operating a mobile high-temperature membrane (HTM) fuel cell battery containing a stack having at least one HTM fuel cell with an electrolyte containing phosphoric acid. During a cooling down of the HTM fuel cell from a working temperature, water is metered to the phosphoric acid and/or generated in the HTM fuel cell to be added to the phosphoric acid in an amount of from 30 to 60% by weight, with a result that a freezing point of the phosphoric acid is reduced to a desired level for improving start/stop operations.

Other features which are considered as characteristic for the invention are set forth in the appended claims.

Although the invention is described herein as embodied in a method for operating a HTM fuel cell and a HTM fuel cell battery, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

The term high-temperature membrane (HTM) fuel cell denotes any fuel cell that includes a conventional electrolyte membrane and/or contains a membrane as a matrix for physically and/or chemically holding the electrolyte as its core piece and an operating temperature of which is higher than that of the conventional PEM fuel cell, i.e. higher than 80° C., preferably higher than 100° C. The maximum operating temperature is approximately 220° C. The HTM fuel cell has an electrolyte that has a good conductivity in a nonaqueous environment at the above-mentioned temperatures.

According to an advantageous configuration of the invention, the additive is water, which is added in a quantity of from 20-80% by weight, preferably 30-60% by weight and particularly preferably 40-57% by weight. During operation, the water evaporates without leaving a residue.

According to an advantageous configuration of the method, during cooling of the fuel cell battery, when the temperature of the electrolyte is between 45 and 100° C., a defined quantity of water is metered to the electrolyte. The quantity of water is set by selecting the desired operating parameters and optionally the water can be generated in the cell with the aid of the platinum catalyst, and in this way the correct dilution is established.

The generation of water with the aid of the platinum catalyst is carried out by metering air to the anode and/or hydrogen to the cathode, so that the catalyst, as a catalytic burner, recombines the two gases in a controlled manner and, in the process, produces water, so that the by-product water at temperatures of below 100° C. is no longer carried away in gas form by the cathode exhaust gas, but rather dilutes the electrolyte.

To control the addition of water and/or additive, the electrical resistance of the cell, for example, is monitored. Depending on the ambient temperature and, for example, the time of year, the reduction in the freezing point can then be set in a controlled manner, for example taking account of the H₃PO₄/H₂O phase diagram.

To control the reduction in the freezing point, according to one embodiment, a control unit is provided, to which at least the following data is input: desired freezing point, instantaneous electrolyte resistance and the instantaneous temperature in the cell. The control unit then outputs the quantity and/or duration of the addition of water to the electrolyte (if appropriate indirectly by metering oxidizing agent to the anode and/or fuel to the cathode).

The HTM fuel cell electrolyte contains phosphoric acid, the normal freezing point of which, which is 42° C., is reduced by the addition of at least one additive to such an extent that it is possible to achieve start/stop operation of the fuel cell, as is required, for example, in mobile applications of the fuel cell.

We claim:

1. A method for operating a high-temperature membrane (HTM) fuel cell having an electrolyte containing phosphoric acid, which comprises the steps of:
during a cooling down of the HTM fuel cell from a working temperature, performing at least one of metering water to the phosphoric acid and generating the water in the HTM fuel cell added to the phosphoric acid in an amount of from 30 to 60% by weight, with a result that a freezing point of the phosphoric acid is reduced to a desired level.

2. The method according to claim 1, which comprises selecting the amount of the water to be in a range from 40 to 57% by weight of the phosphoric acid.

3. The method according to claim 1, which comprises selecting the amount of the water such that the freezing point of the phosphoric acid is reduced by at least 40° C.

4. The method according to claim 1, which comprises:
using hydrogen as a fuel gas and air as an oxidizing agent in the HTM fuel cell; and
metering the air to the hydrogen at an anode and the hydrogen is metered to oxygen at a cathode, in an amount which is such that the amount of the water generated reduces the freezing point of the phosphoric acid by at least 40° C.

5. The method according to claim 1, which comprises monitoring an electrical resistance of the HTM fuel cell for controlling the metering of the water and the generation of the water.

6. The method according to claim 1, which comprises using the HTM fuel cell in a HTM fuel cell battery.

7. A method for operating a mobile high-temperature membrane (HTM) fuel cell battery containing a stack having at least one HTM fuel cell with an electrolyte containing phosphoric acid, which comprises the steps of:
during a cooling down of the HTM fuel cell from a working temperature, performing at least one of metering water to the phosphoric acid and generating water in the HTM fuel cell added to the phosphoric acid in an amount of from 30 to 60% by weight, with a result that a freezing point of the phosphoric acid is reduced to a desired level for improving start/stop operations.
